(19) United States
(12) Patent Application Publication
(10) Pub. No.: US 2025/0282179 A1
(43) Pub. Date: Sep. 11, 2025

(54) TIRE INNER TUBE

(71) Applicant: TOMIKA TECHNOLOGY CO., LTD., YONGJING TOWNSHIP (TW)

(72) Inventors: AO-LI CHANG, YONGJING TOWNSHIP (TW); PO-YA YU, YONGJING TOWNSHIP (TW)

(73) Assignee: TOMIKA TECHNOLOGY CO., LTD., YONGJING TOWNSHIP (TW)

(21) Appl. No.: 18/889,652

(22) Filed: Sep. 19, 2024

(30) Foreign Application Priority Data
Mar. 5, 2024 (TW) 113202201

(51) Int. Cl. B60C 5/04

(52) U.S. Cl. CPC B60C 5/04

(57) ABSTRACT

A tire inner tube includes a torus body having an outer circumferential side and an inner circumferential side opposite to the outer circumferential side, and an air nozzle stem protruding from the inner circumferential side and communicating with an inside of the torus body. The torus body is made of a thermoplastic elastomer sheet material, and has first and second overlap connecting parts. The first overlap connecting part is distributed in a complete circle along a toroidal direction of the torus body, and has first and second connecting sheets overlapped and fixed to each other. The second overlap connecting part is distributed in a complete circle along a poloidal direction of the torus body, and has first and second tube end portions overlappingly sleeved and fixed with each other. As a result, the tire inner tube is easily manufactured with a high structural strength.

### BACKGROUND OF THE INVENTION

### 1. Field of the Invention

The present invention relates generally to tires of vehicles and more particularly, to a tire inner tube made of thermoplastic elastomer material.

### 2. Description of the Related Art

Taiwan Patent Publication No. 200934652 disclosed a manufacturing method and a forming mold for a non-vulcanized inner tube, including an inner tube billet and a forming mold having an arc extrusion pathway. The inner tube billet is extruded through the arc extrusion pathway to be formed into an arc pipe for the inner tube, and an air nozzle component is connected to the cylindrical pipe wall of the pipe for the inner tube. After that, two open ends of the pipe are folded outward and then connected with each other so that the pipe is made into a finished non-vulcanized inner tube.

Although the finished non-vulcanized inner tube manufactured by using the manufacturing method disclosed in the aforementioned patent has excellent circularity, molds of different sizes should be prepared for manufacturing inner tubes of different tube diameters so that the finished inner tubes can be applied to tires of different sizes. That will cause a hoard of the finished inner tubes or molds, thereby unduly increasing inventory cost. In other words, the non-vulcanized inner tube with the above-described structure has the problems of difficulty in manufacturing and high cost, and thereby still needs improvement.

### SUMMARY OF THE INVENTION

The present invention has been accomplished in view of the above-noted circumstances. It is a primary objective of the present invention to provide a tire inner tube which has such special structure that can be manufactured easily.

It is another objective of the present invention to provide a tire inner tube which has such special structure that the structural strength of the inner tube is improved.

To attain the above objective, the present invention provides a tire inner tube comprising a torus body and an air nozzle stem. The torus body has an outer circumferential side and an inner circumferential side opposite to the outer circumferential side. The air nozzle stem protrudes from the inner circumferential side, and communicates with the inside of the torus body. The torus body is formed by a sheet material made of a thermoplastic elastomer material, and has a first overlap connecting part and a second overlap connecting part. The first overlap connecting part is distributed in a complete circle along a toroidal direction of the torus body, and has a first connecting sheet and a second connecting sheet, which are overlapped and fixed to each other. The second overlap connecting part is distributed in another complete circle along a poloidal direction of the torus body, and has a first tube end portion and a second tube end portion, which are overlappingly sleeved and fixed with each other.

By the above-described technical features, the torus body is manufactured by overlapping and connecting the sheet material made of the thermoplastic elastomer material without using any extrusion forming mold, so the manufacture of the torus body is relatively easier. Besides, by adjusting the size of the sheet material or adjusting the overlap width of the first and second connecting sheets and/or the first and second tube end portions, the tire inner tube can be manufactured with various sizes (tube diameter and/or tire diameter), so the tire inner tube of the present invention further has the advantages of high production flexibility and high production efficiency. In addition, there are the first and second overlap connecting parts distributed in the complete circles along the toroidal direction and the poloidal direction respectively, which can be regarded as double-layer reinforcing structures, so the tire inner tube of the present invention may have a structural strength better than that of the extrusion-formed single-layer inner tube.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a tire inner tube according to a first preferred embodiment of the present invention;

FIG. 2 is a sectional view taken along the line 2-2 in FIG. 1;

FIG. 3 is a sectional view taken along the line 3-3 in FIG. 1;

FIG. 4 is a schematic view of a manufacturing process, showing the steps of manufacturing the tire inner tube according to the first preferred embodiment of the present invention;

FIG. 5 is a schematic perspective view showing that the tire inner tube according to the first preferred embodiment of the present invention is installed between a tire casing and a wheel rim; and

FIG. 6 is a schematic view of another manufacturing process, showing the steps of manufacturing a tire inner tube according to a second preferred embodiment of the present invention.

### DETAILED DESCRIPTION OF THE INVENTION

For the detailed description of the technical features of the present invention, the structure and manufacturing method of the present invention will be described hereinafter in conjunction with the appendixed figures. It is to be mentioned that the figures of the present invention are only schematic views for illustrating the technical features of the present invention, not drawn according to the real size and scale.

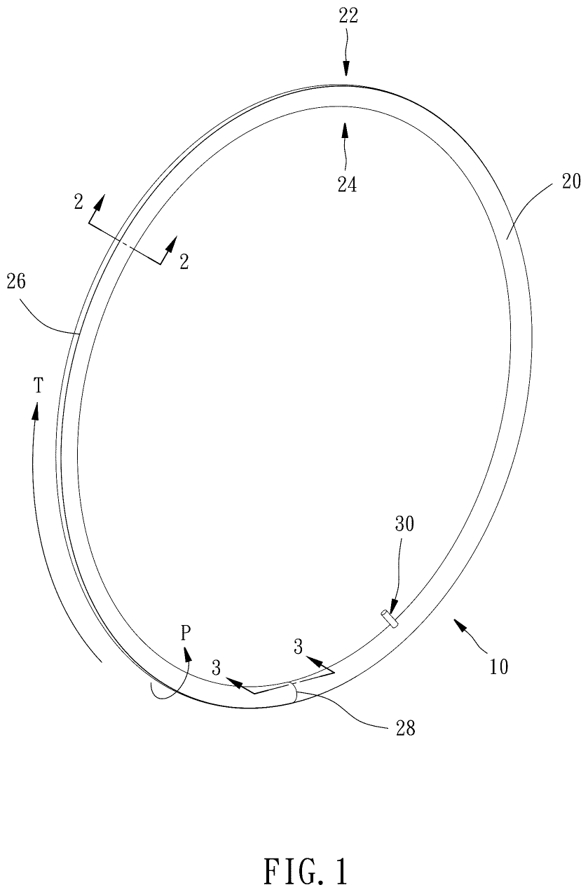

Referring to FIG. 1 to FIG. 3, a tire inner tube 10 according to a first preferred embodiment of the present invention primarily includes a torus body 20 and an air nozzle stem 30. The torus body 20 has an outer circumferential side 22 and an inner circumferential side 24 opposite to the outer circumferential side 22. The air nozzle stem 30 is fixedly connected to the torus body 20, protrudes from the inner circumferential side 24, and communicates with the inside of the torus body 20. As a result, the torus body 20 can be inflated through the air nozzle stem 30.

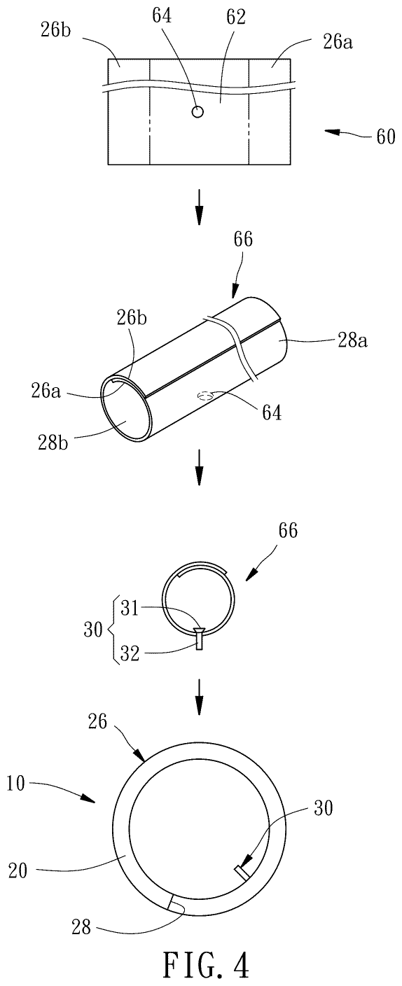

Referring to FIG. 4 as well, the primary technical feature of the tire inner tube 10 of the present invention lies in that the torus body 20 is made of a sheet material 60 made of a thermoplastic elastomer material (the manufacturing method will be specified hereinafter), and has a first overlap connecting part 26 and a second overlap connecting part 28.

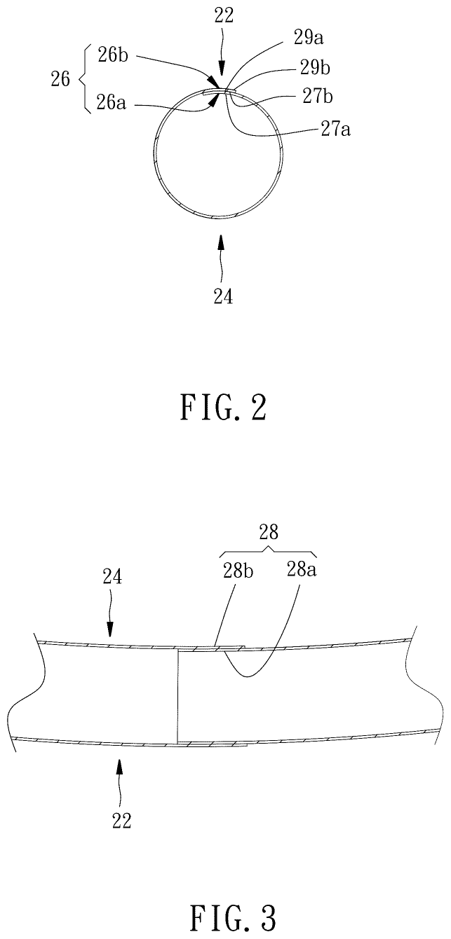

As shown in FIGS. 1 and 2, the first overlap connecting part 26 is distributed in a complete circle along a toroidal direction T of the torus body 20, and has a first connecting sheet 26a and a second connecting sheet 26b, which are overlapped and fixed to each other. Specifically speaking, the first connecting sheet 26a has an inner surface 27a and an outer surface 29a, the second connecting sheet 26b has an inner surface 27b and an outer surface 29b, and the inner surface 27b of the second connecting sheet 26b is overlapped with and fixed to the outer surface 29a of the first connecting sheet 26a.

As shown in FIGS. 1 and 3, the second overlap connecting part 28 is distributed in another complete circle along a poloidal direction P of the torus body 20, perpendicularly intersects the aforementioned first overlap connecting part 26, and has a first tube end portion 28a and a second tube end portion 28b, which are overlapped in a sleeved manner and fixed to each other. Specifically speaking, each of the first tube end portion 28a and the second tube end portion 28b has an inner surface and an outer surface. The first tube end portion 28a is inserted in the second tube end portion 28b in a way that the inner surface of the second tube end portion 28b is overlapped with and fixed to the outer surface of the first tube end portion 28a.

In this embodiment, the first overlap connecting part 26 is distributed in a complete circle along the outer circumferential side 22 of the torus body 20. However, in another embodiment of the present invention, the first overlap connecting part 26 may be distributed in a complete circle along the inner circumferential side 24 of the torus body 20. In still another embodiment of the present invention, the torus body 20 may have two first overlap connecting parts 26 distributed in two complete circles along the outer circumferential side 22 and the inner circumferential side 24 of the torus body 20 respectively.

The method of manufacturing the tire inner tube provided by the present invention includes the steps of:
a) providing a sheet material, the sheet material being made of a thermoplastic elastomer material and having a central part, and a first connecting sheet and a second connecting sheet, which are connected to two sides of the central part respectively, each of the first connecting sheet and the second connecting sheet having an inner surface and an outer surface;
b) rolling up the sheet material into a tube, the tube having a first tube end portion, a second tube end portion, and a first overlap connecting part formed in a way that the inner surface of one of the first connecting sheet and the second connecting sheet is overlapped with the outer surface of the other of the first connecting sheet and the second connecting sheet, and the first connecting sheet and the second connecting sheet are fixedly connected with each other to be formed into the first overlap connecting part; and
c) overlappingly sleeving and fixedly connecting the first tube end portion and the second tube end portion of the tube with each other to form a second overlap connecting part, so that the tube is formed into a circle-shaped tire inner tube having the first overlap connecting part distributed in a complete circle along a toroidal direction of the tire inner tube and the second overlap connecting part distributed in a complete circle along a poloidal direction of the tire inner tube.

Specifically speaking, the manufacturing process of the tire inner tube 10 according to the first preferred embodiment of the present invention is schematically illustrated in FIG. 4. During the manufacture, a sheet material 60 made of a thermoplastic elastomer material is provided at first. In this embodiment, the width of the sheet material 60 (the length in the horizontal direction in the figure) is far smaller than the length of the sheet material 60 (the length in the vertical direction in the figure). The sheet material 60 has a central part 62, a first connecting sheet 26a adjacent to the right edge and having a predetermined width, and a second connecting sheet 26b adjacent to the left edge and having a predetermined width. Besides, the central part 62 has a through hole 64. In this embodiment, the thermoplastic elastomer may be thermoplastic polyurethane (TPU), thermoplastic polyamide (TPA), thermoplastic polyester elastomer (TPEE), thermoplastic vulcanizate (TPV), thermoplastic polyolefin (TPO), thermoplastic styrene (TPS), thermoplastic rubber (TPR), polyvinyl butyral (PVB) or the mixture of two or more than two aforementioned materials. In the practical application, the sheet material 60 made of the thermoplastic elastomer material can be rolled up and then cut, or cut and then rolled up, to become a plurality of rolls (not shown) of different widths for easy storage. After that, the roll with proper width can be picked according to the practical requirement, and the sheet material 60 can be pulled out for the required length.

After that, as the second step shown in FIG. 4, the first connecting sheet 26a and the second connecting sheet 26b of the sheet material 60 are overlapped with each other, and then a fusion connecting process is performed to the overlap of the first connecting sheet 26a and the second connecting sheet 26b by a connecting way, such as, but unlimited to, high-frequency welding, microwave welding, laser welding, ultrasonic welding or thermocompression, making the overlap of the first connecting sheet 26a and the second connecting sheet 26b fused and fixedly connected with each other to become an integral, so that a tube 66 with predetermined length and tube diameter is formed. In this way, as shown in FIG. 4, the tube 66 has the first connecting sheet 26a and the second connecting sheet 26b, which extend along the longitudinal direction of the tube 66 and are fixedly overlapped and connected with each other for a predetermined width. Besides, the tube 66 is formed at two ends thereof with the first tube end portion 28a and the second tube end portion 28b having openings, respectively.

After that, as the third step shown in FIG. 4, an air nozzle stem 30 is provided, and the air nozzle stem 30 is fixedly installed to the tube 66. Specifically speaking, the air nozzle stem 30 has a base 31 and a stem body 32 fixedly connected to the base 31. The base 31 may be made of a thermoplastic elastomer material, such as thermoplastic polyurethane (TPU), thermoplastic polyamide (TPA), thermoplastic polyester elastomer (TPEE), thermoplastic vulcanizate (TPV), thermoplastic polyolefin (TPO), thermoplastic styrene (TPS), thermoplastic rubber (TPR), polyvinyl butyral (PVB) or the mixture of two or more than two aforementioned materials by injection molding. The stem body 32 of the air nozzle stem 30 may be a metal tube, such as copper tube or aluminum tube, and fixed to the base 31 in an embedded bonding manner. Alternatively, the stem body 32 may be a tube made of the aforementioned thermoplastic elastomer material integrally formed with the base 31 by injection molding.

During the installation of the air nozzle stem 30, at first, the air nozzle stem 30 is placed into the tube 66 through the first tube end portion 28a or the second tube end portion 28b in a way that the base 31 is attached on the inner wall surface of the tube 66 and the stem body 32 is inserted through the through hole 64 to protrude out. Then, the base 31 is fixedly combined with the inner wall surface of the tube 66 by a processing way, such as high-frequency welding, microwave welding, laser welding, ultrasonic welding or thermocompression.

At last, the whole first tube end portion 28a of the tube 66 is inserted into the second tube end portion 28b through the opening of the second tube end portion 28b, so that the first tube end portion 28a and the second tube end portion 28b are overlapped with each other. Then, a fusion connecting process is performed to the overlap of the first tube end portion 28a and the second tube end portion 28b by a connecting way, such as, but unlimited to, high-frequency welding, microwave welding, laser welding, ultrasonic welding or thermocompression, making the overlap of the first tube end portion 28a and the second tube end portion 28b fused and fixedly connected with each other to become an integral, so that the tire inner tube 10 as shown in the fourth step in FIG. 4 and as shown in FIG. 1 is accomplished. In other words, the aforementioned tube 66 is formed into the torus body 20 of the tire inner tube 10, where the first connecting sheet 26a and the second connecting sheet 26b are overlapped and fixed to each other is formed into the first overlap connecting part 26, and where the first tube end portion 28a and the second tube end portion 28b are overlapped and fixed to each other is formed into the second overlap connecting part 28. Before the above-described step of inserting the first tube end portion 28a into the second tube end portion 28b, release agent can be sprayed into the first tube end portion 28a, so that the inner surface of the first tube end portion 28a can be prevented from self-attaching caused by the aforementioned fusion connecting process.

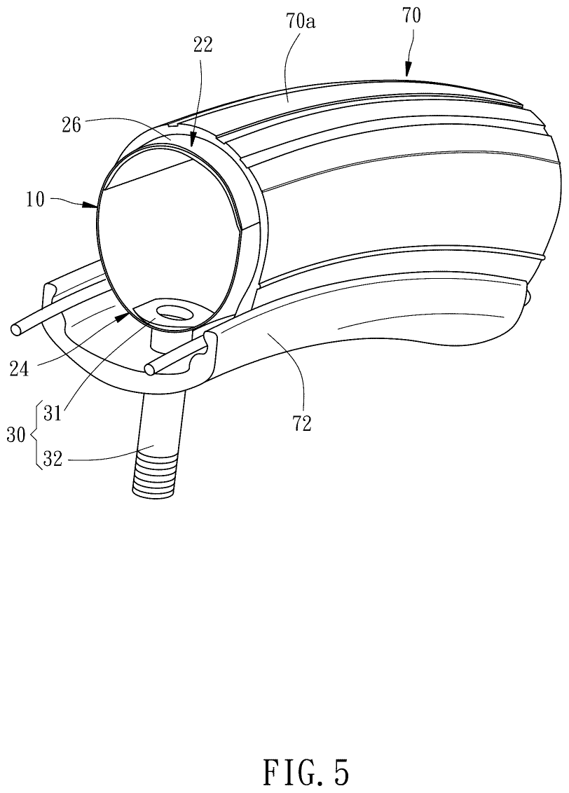

FIG. 5 illustrates the state that the tire inner tube 10 according to the first preferred embodiment of the present invention is installed between a tire casing 70 and a wheel rim 72. As shown in FIG. 5, after the installation of the tire inner tube 10, the inner circumferential side 24 fixed with the air nozzle stem 30 is located correspondingly to the wheel rim 72, and the stem body 32 is inserted through an air nozzle through hole of the wheel rim 72 to protrude from the inner circumferential side of the wheel rim 72. The outer circumferential side 22 is located correspondingly to the tread 70a of the tire casing 70 for contacting the ground.

It can be known from the above description that for the tire inner tube 10 according to the first embodiment of the present invention, the torus body 20 has the special structural design such as the first and second overlap connecting parts 26 and 28, so that the torus body 20 can be directly made of the sheet material 60 made of the thermoplastic elastomer material in a way that the first and second connecting sheets 26a and 26b are overlapped in a planar manner and fused with each other, and the first and second tube end portions 28a and 28b are overlapped in a sleeved manner and fused with each other, which needs not to use any extrusion forming mold. Therefore, the manufacture of the tire inner tube 10 of the present invention is relatively easier and simpler. Besides, by providing the sheet material 60 of different width or adjusting the overlap width of the first and second connecting sheets 26a and 26b, the tire inner tube 10 can be manufactured with various tube diameter. By providing the sheet material 60 of different length or adjusting the sleeved and overlapped length of the first and second tube end portions 28a and 28b, the tire inner tube 10 can be manufactured with various tire diameter. Therefore, the tire inner tube 10 of the present invention further has the advantages of high production flexibility and high production efficiency. In addition, there are the first and second overlap connecting parts 26 and 28 distributed in the complete circles along the toroidal direction T and the poloidal direction P respectively, serving as double-layer overlapped and connected reinforcing structures, so that the tire inner tube of the present invention may have a good structural strength compared to the conventional extrusion-formed single-layer inner tube or the conventional inner tube with the connection design that two open ends of a pipe are folded outward and then connected with each other. Furthermore, as shown in FIG. 5, when the tire inner tube 10 is installed in the tire casing 70, the first overlap connecting part 26 located on the outer circumferential side 22 and formed from the first and second connecting sheets 26a and 26b in a double-layer overlapped and fixed manner is located correspondingly to the tread 70a of the tire casing 70, so this part of the tire inner tube 10 has improved puncture resistance.

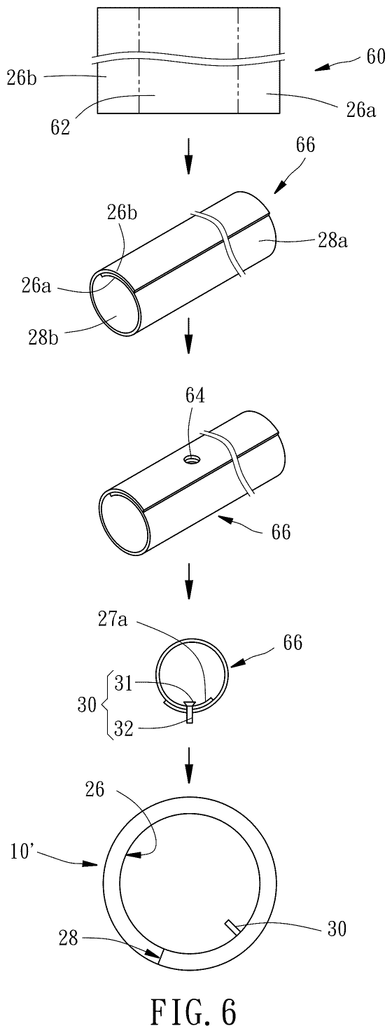

Based on the above-described technical features and the spirit of the design of the present invention, the tire inner tube provided by the present invention may have various modifications. For example, FIG. 6 schematically illustrates a manufacturing process of a tire inner tube 10′ according to a second preferred embodiment of the present invention, which is primarily different from the tire inner tube 10 provided in the first embodiment in that as the second and third steps shown in FIG. 6, after the sheet material 60 is formed into the tube 66, the through hole 64 for the air nozzle stem 30 to be inserted therethrough is provided by processing the tube 66 at the overlap of the first and second connecting sheets 26a and 26b. In other words, in the present invention, the timing and position for providing the through hole 64 by processing is not particularly restricted. Besides, the first overlap connecting part 26 is formed on the inner circumferential side 24 of the torus body 20. In this way, when the air nozzle stem 30 is fixedly connected to the first overlap connecting part 26 provided with the through hole 64, the base 31 is fixed to the inner surface 27a of the first connecting sheet 26a, the stem body 32 is inserted through the first connecting sheet 26a and the second connecting sheet 26b to protrude from the inner circumferential side 24 of the torus body 20, and the first overlap connecting part 26 can provide relatively higher structural strength so as to provide relatively better air tightness and binding stability. Besides, in the present invention, the sheet material 60 for being made into the torus body 20 may have the central part 62 thicker in thickness and the first and second connecting sheets 26a and 26b thinner in thickness. In this way, after the first and second connecting sheets 26a and 26b are overlapped and fixed to each other to be formed into the first overlap connecting part 26, the thickness of the first overlap connecting part 26 can be close to or equal to the thickness of the central part 62, so that the whole tire inner tube 10 is relatively more uniform in sectional thickness, resulting in that when the tire inner tube 10 is inflated, the tire pressure is distributed more evenly and thereby the tire inner tube 10 is prevented from bulging at specific parts thereof.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tire inner tube comprising:
a torus body having an outer circumferential side and an inner circumferential side opposite to the outer circumferential side; and
an air nozzle stem protruding from the inner circumferential side and communicating with an inside of the torus body;
the tire inner tube being characterized in that:
the torus body is formed by a sheet material made of a thermoplastic elastomer material, and has a first overlap connecting part and a second overlap connecting part;
wherein the first overlap connecting part is distributed in a complete circle along a toroidal direction of the torus body, and has a first connecting sheet and a second connecting sheet, which are overlapped and fixed to each other;
wherein the second overlap connecting part is distributed in a complete circle along a poloidal direction of the torus body, and has a first tube end portion and a second tube end portion, which are overlapping sleeved and fixed with each other.

2. The tire inner tube as claimed in claim 1, wherein the first overlap connecting part is distributed in the complete circle along the outer circumferential side of the torus body.

3. The tire inner tube as claimed in claim 1, wherein the first overlap connecting part is distributed in the complete circle along the inner circumferential side of the torus body.

4. The tire inner tube as claimed in claim 3, wherein each of the first connecting sheet and the second connecting sheet has an inner surface and an outer surface, and the inner surface of the second connecting sheet is overlapped with and fixed to the outer surface of the first connecting sheet; the air nozzle stem has a base and a stem body; the base is fixed to the inner surface of the first connecting sheet; the stem body is inserted through the first connecting sheet and the second connecting sheet to protrude from the inner circumferential side of the torus body.

5. The tire inner tube as claimed in claim 1, wherein the thermoplastic elastomer material is selected from a group consisting of thermoplastic polyurethane (TPU), thermoplastic polyamide (TPA), thermoplastic polyester elastomer (TPEE), thermoplastic vulcanizate (TPV), thermoplastic polyolefin (TPO), thermoplastic styrene (TPS), thermoplastic rubber (TPR), polyvinyl butyral (PVB) and mixtures thereof.

6. The tire inner tube as claimed in claim 5, wherein the first connecting sheet and the second connecting sheet are fixed to each other by one of high-frequency welding, microwave welding, laser welding, ultrasonic welding and thermocompression, thereby formed into the first overlap connecting part.

7. The tire inner tube as claimed in claim 5, wherein the first tube end portion and the second tube end portion are fixed to each other by one of high-frequency welding, microwave welding, laser welding, ultrasonic welding and thermocompression, thereby formed into the second overlap connecting part.
